(19) United States
(12) Patent Application Publication
(10) Pub. No.: US 2020/0334772 A1
(43) Pub. Date: Oct. 22, 2020

(54) Computerized System and Computerized Method of Dispute Resolution

(71) Applicant: Gal Gorodeisky, Tel Aviv (IL)

(72) Inventor: Gal Gorodeisky, Tel Aviv (IL)

(21) Appl. No.: 16/387,606

(22) Filed: Apr. 18, 2019

(51) Int. Cl. G06Q 50/18; G06N 3/08; G06F 17/27

(52) U.S. Cl. CPC G06Q 50/182; G06F 17/2775; G06N 3/08

(57) ABSTRACT

Computerized system and computerized method of dispute resolution. For example, a system receives statements or claims from a first party and a second party, with regard to a legal dispute between them. The system shows to each party, the statements made by the other party; and requests each party to respond with True or False or Pass. The system requests each party to explain with a new statement, each adverse statement that he did not agree too. The system performs multiple iterations of obtaining statements, response answers of True or False or Pass, and additional statements that further clarify the position of each party. The system operates to effectively reduce or narrow-down the disagreements between the parties, or to pin-point the actual core of the dispute between them.

### FIELD

Some embodiments relate to the field of information technology.

### BACKGROUND

Millions of people worldwide utilize electronic devices for various purposes on a daily basis. For example, people utilize a laptop computer, a desktop computer, a smartphone, a tablet, and other electronic devices, in order to send and receive electronic mail (e-mail), to browse the Internet, to play games, to consume audio/video and digital content, to engage in Instant Messaging (IM) and video conferences, to perform online banking transactions and online shopping, and to do various other tasks.

Attorneys, lawyers, legal counsels, and parties to a legal dispute utilize computers in some particular ways; for example, by using a word processing software to author papers, by sending files via electronic mail (email) between an attorney and his client, or by using a computerized docketing system that may assist an attorney in monitoring legal deadlines and due dates to perform certain legal actions.

### SUMMARY

The present invention provides computerized systems, devices, and methods of dispute resolution or dispute mitigation. For example, a system receives statements or claims from a first party and a second party, with regard to a legal dispute between them. The system shows to each party, the statements made by the other party; and requests each party to respond with True or False or Pass. The system requests each party to explain with a new statement, each adverse statement that he did not agree to. The system performs multiple iterations of obtaining statements, response answers of True or False or Pass, and additional statements that further clarify the position of each party. The system operates to effectively reduce or narrow-down the disagreements between the parties, or to pin-point the actual core of the dispute between them.

### BRIEF DESCRIPTION OF THE DRAWINGS

FIG. 1 is a schematic illustration of a computerized method, in accordance with some demonstrative embodiments of the present invention.

FIG. 2 is a schematic illustration of a demonstrative computerized method in the context of a labor law dispute or employment law dispute, in accordance with some demonstrative embodiments of the present invention.

FIG. 3 is a schematic illustration of a demonstrative computerized method in the context of a family law dispute, in accordance with some demonstrative embodiments of the present invention.

FIG. 4 is a schematic illustration of a demonstrative computerized method in the context of an insurance law dispute, in accordance with some demonstrative embodiments of the present invention.

FIG. 5 is a schematic illustration of a demonstrative computerized method in the context of a real estate law dispute or a construction law dispute, in accordance with some demonstrative embodiments of the present invention.

FIG. 6 is a schematic block-diagram illustration of a computerized system, in accordance with some demonstrative embodiments of the present invention.

### DETAILED DESCRIPTION OF SOME DEMONSTRATIVE EMBODIMENTS OF THE PRESENT INVENTION

The present invention provides computerized systems and methods (or digital systems, digital methods, computer-implemented systems, computer-implemented methods, electronic systems, electronic methods, electronically-implemented systems, electronically-implemented methods, machine-implemented systems, machine-implemented methods) for dispute resolution or for dispute mitigation; or for narrowing-down or pin-pointing one or more particular issues that are at dispute between two parties or among multiple parties, particularly between or among parties to a legal dispute (e.g., plaintiff and defendant; or, potential plaintiff and potential defendant). Some embodiments of the present invention may particularly provide a computerized Binary Dispute Resolution (BDR) system, which generates an open, concise and focused step-by-step or turn-by-turn communication channel between two adverse parties, or among multiple parties to a legal dispute; which enables each arty to provide short positive claims or arguments or allegations or legal claims or legal facts, or a combination of such items; and further enables each other party or each adverse party to respond to the claims or arguments that were set forth by said party. In some embodiments, the response of one party to an allegation or claim or argument by the other party, is limited to a selection among exactly three response options, which are “I agree” or “I do not agree” or “I pass/I skip/I do not wish to respond to this item” (or equivalent or similar responses). Through the computerized system of the present invention, the parties to the dispute may dissolve the conflict, or the conflict or dispute may be minimized or mitigated, or the system may pin-point and determine or detect the particular point that is at the center of the legal dispute, while removing from the table other facts or other arguments that are not in dispute among the parties involved; thereby enabling the computerized system to increases the willingness of both parties, or of at least one of the parties involved, to consent to a possible resolution of the dispute, and/or to enable turning disagreements into agreements or into partial agreements or into smaller-size disagreements or into a list or a set of discrete items that reflect narrow points of disagreement between or among the parties involved.

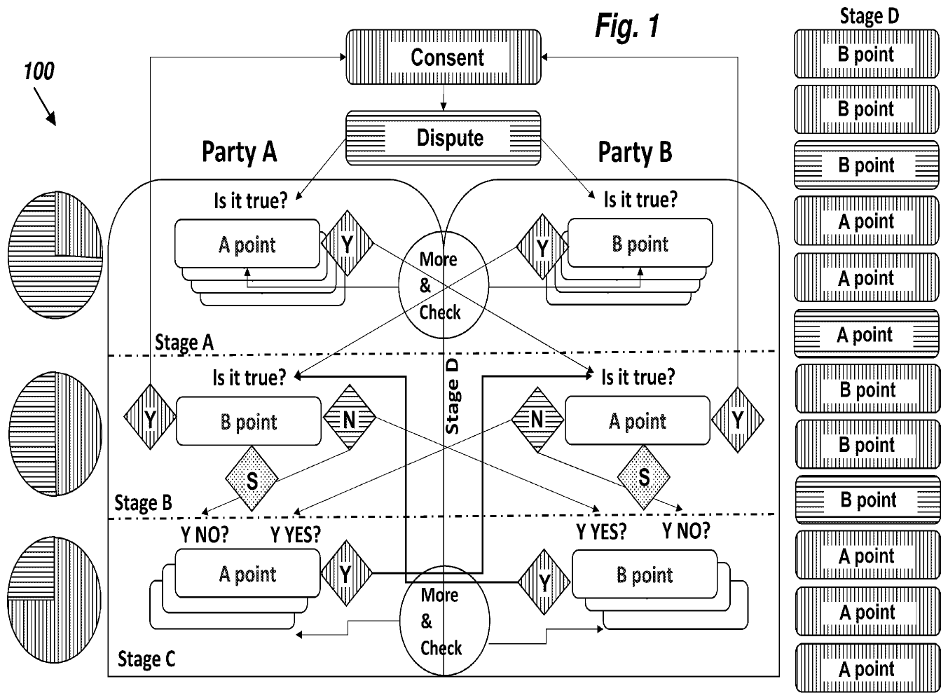

Reference is made to FIG. 1, which is a schematic illustration of a computerized method 100, in accordance with some demonstrative embodiments of the present invention. An initial registration or log-in stage may be performed, in which each one of two parties, denoted as Party A and Party B, may register and/or log-in to the system, directly and/or via an attorney or lawyer or other representative or agent. The computerized method may be performed over multiple stages or phases; such as, stages A through D, or stages A through E, as described herein.

In Stage A, each party provides to the system his short statements of claims and/or defenses. For example, each party phrases his stance in the case or in the dispute, dividing it to short discrete sentences or phrases or textual elements in a natural language (e.g., in English). Each such discrete sentence will be considered and later utilized as a claim or a point, in the ongoing dispute. Each such sentence or phrase may express the claim succinctly in a positive way, in a focused and concise manner.

Upon entry of each claim by Party A, the system asks or verifies with Party A that those claims are indeed true and correct; for example, by requesting the confirmation input of Party A immediately after entry of each claim of Party A, and/or by requesting the bulk confirmation input of Party A to the entire set of his claims, or to groups or batches of his claims (e.g., “please confirm the correctness of your claims number 1 through 5”). Accordingly, Party A is required to confirm the correctness and/or truthfulness of each claim (phrase, statement, stance, position) that he provided to the system.

Party A may provide or may input his claims into the system via one or more suitable ways; for example, by typing his claims into a computer or computerized terminal (e.g., via a keyboard); by utilizing a touch-based device or a touch-screen of an electronic device (e.g., of a laptop computer, of a tablet, or a smartphone); by dictating his sentences into a microphone, such that the dictated speech is then converted automatically into text via a speech-to-text converter; by importing his sentences or his claims from an external source, such as, an online repository of data that he already prepared, or a word processing document or a spreadsheet file that he prepared, or other suitable data-set that can be fetched or obtained or that may be uploaded to the system; or by a combination of such methods.

Party A is then asked by the system whether he has completed his input, or whether he has additional claims or sentences or questions to input; and Party A concludes his portion of Stage A by indicating to the system that he has indeed completed his input. Optionally, the system may then ask or re-ask Party A, to confirm or to re-confirm the correctness and/or truthfulness. The re-confirmation of each claim or statement, may be requested on a claim-by-claim basis or on a statement-by-statement basis (e.g., immediately after Party A enters or provides each statement or each claim), and/or may be performed in bulk with regard to a group or batch of statements or claims that were entered by Party A.

In some embodiments, Party A is required to positively confirm the correctness of each and every claim that he inputs into the system, as a condition for the system to proceed and/or to utilize those claims for obtaining the reaction of the other party. In other embodiments, optionally, the system may allow Party A to indicate, for up to N percent of his claims (wherein N may be, for example, 100 percent; or 50 percent), or for up to M of his claims (wherein M may be, for example, 3 claims or 5 claims), that Party A is not sure about their correctness, or that Party A makes those statements “upon information and belief”, or that Party A truly does not know whether those specific statements are correct or incorrect (e.g., a statement by Party A that “Party B is a citizen of France”). In still other embodiments, the system may be implemented in a way that forces each party to be concise and decisive, and to not allow a party to indicate that he is “unsure” about the correctness of a claim or a statement; but rather, to force a party to relate on the merits to each claim, and/or to force a party to deny a claim or to deny a statement if that party is unsure of its correctness and/or if that party truly does not know whether it is correct or incorrect (e.g., Party A may deny Party B's statement that “Party B is a citizen of France”, because Party A does not know whether this claims of Party B is true or false).

Party B may similarly enter or input into the system his claims or statements. This may be done in parallel to Party A entering his statements or claims; or concurrently or generally simultaneously with Party A; or within an allocated time-slot or time window; or after Party A has entered some or all of his claims. In some embodiments, for example, the system may allow each party to enter all of his claims and statements, within 48 hours of registering to the system, or within 72 hours of commencing a dispute by either Party A or Party B, or within 96 hours of both Parties A and B providing their consent to utilize the computerized system; or within other suitable time frame.

In Stage B of the computerized method, the system sends the claims to the party that is adverse to the party who provided them, to obtain response or reaction. The sending may be performed electronically or digitally, via the computerized system, via email, via text messages, via a dedicated application or “app” or mobile application, via a website or web-page, or the like; and need not require the actual printing of papers and delivery of printed papers to the other party. In some embodiments, the sending of claims to the other party is performed by the system if, or when, one or more conditions hold true; for example, in some embodiments, the statements of Party A are sent to Party B immediately upon obtaining the confirmation of Party A that he concluded entering all his claims; or, immediately upon conclusion of the entry of claims by both Party A and Party B; or at a particular pre-defined time-point (e.g., exactly 72 hours after both parties have consented to use the computerized system). In some embodiments, immediately upon entry (and confirmation) of each claim or statement, by Party A, that claim or statement immediately becomes available to be viewed by Party B and to be responded by Party B; and similarly, immediately upon entry (and confirmation) of any claim or statement, by Party B, that claim or statement immediately becomes available to be viewed by Party A and to be responded by Party A; thereby enabling a continuous and dynamic back-and-forth dialogue between the parties, and/or thereby shortening or eliminating unnecessary delays in communications.

Accordingly, Stage B of the computerized method includes the automatic exchange of claims among the parties, and obtaining their responses. For example, in Stage A, Party A has entered seven claims; and in Stage B, those seven claims are sent to Party B, and the system collects or receives from Party B his response to each one of those seven claims that were generated by Party A. In some embodiments, the “sending” of those seven claims of Party A, to Party B, may be done on a claim-by-claim basis, immediately upon the entry (and confirmation) of each claim by Party A.

For each one of those statements, the system may ask Party B a questions such as, “is this statement correct?” or “do you agree with this statement?” or “is this statement undisputed?”; and the system may allow Party B to provide exactly one response, to each such statement or claim, out of three possible responses; which in some embodiments are: either “Yes” (positive, affirmative, True) or “No” (false, negative, untrue) or “Skip” (e.g., “I wish to skip this item”, or “I do not currently have a response to this item”, or “I do not think this questions is relevant”, or “I do not currently wish to reply”). In some embodiments, the system may enforce a limit on the number of statements (e.g., not more than 3 statements) and/or on the percentage of statements (e.g., not more than 20 percent of statements) that Party B is allowed to respond to with “No”, or with “Skip”, or with either “No” or “Skip”; thereby forcing Party B to respond on the merit to a greater number of statements of Party A, and/or thereby forcing Party B to “keep” his No responses or his Skip responses only to statements of Party A to which he absolutely cannot agree, rather than allowing Party B to answer “no” or “skip to all of Party A statements or to a high percentage of them or to a high number of them.

In some embodiments, statements or claims that are in dispute, are shown to the parties and/or are represented in the system with a first color, such as Red color, or such as over a background of Horizontal lines in the drawings; whereas, statements or claims that are not in dispute, are shown to the parties and/or are represented in the system with a second color, such as Green color, or such as over a background of Vertical lines in the drawings. For example, a statement of Party A, that Party B replies to with “Yes”, becomes an undisputed statement and is colored in Green (or Vertical lines background); whereas, another statement of Party A, that Party B replies to with “No”, becomes a disputed statement and is colored in Red (or Horizontal lines background).

In some embodiments, a response of “Skip” by Party B towards a statement by Party A, may cause that statement be colored in a third color or may be presented in a third type of background. However, in other embodiments, uniquely, a response of “Skip” by Party B towards a statement by Party A, causes that statement be regarded as an undisputed statement, as if Party B has positively agreed to it (since, for example, Party B did not show a sufficient interest to respond to the statement on the merit, or since Party B did not show a sufficient effort to Deny that statement).

Stage C of the computerized method may perform self-resolution and clarification, by way of sorting and agreements. For example, with regard to a statement that was generated by Party A, and that Party B reacted to it as “No” (or False), the system generates: (i) a question to Party B, of “please explain why you marked this statement as False”, and also, (ii) a question to Party A, of “please explain why you marked this statement as True”. The responses of the two parties to these opposite questions, are new textual phrases in concise and succinct language, similar to the original Statements that each Party had generated in Stage A; and each one of these new Response Statements would be considered as New Claims by the party that offered them. The system may request each party to confirm the correctness of each such Response Statement of his, and/or of a batch or group of his Response Statements, and/or of all his Response Statements. Furthermore, the system may request each party to check whether all his Response Statements are indeed necessary and/or relevant to the dispute, and to check whether he can waive or delete any of his Response Statements. In some embodiments, optionally, the system may force a party (e.g., each one of the parties) to necessarily waive or delete at least M response statement(s) out of the response statements that he provided; such as, to delete or to waive at least one (or at least two, or other value) of his response statements, in an effort to reduce the points of dispute between the two parties.

Stage D of the computerized process performs repeating and rephrasing: once each party confirms that all his Response Statements are indeed necessary, they are sent to the other party for counter response; and the system asks the other party “Is it true” or “do you agree” with regard to each Response Statement, and continue iteratively as stated above in stages B and C.

The iterative repetition of Stages B, C and D may inevitably lead to one or more useful outcomes, such as: (a) Increasing the feelings of calmness, at ease, optimism, hope, and/or control with regard to the computerized process; (b) Increasing the willingness of one party, or of both parties, to consent with statements or responses of the other party; (c) Effectively turning certain disagreements into agreements, or certain dispute points to undisputed points; (d) significant reduction in the number of statements or claims, that are still in dispute among the parties; (e) automatic pin-point and detection of a single claim or a single statement, or very few claims or statements, which are the core of the actual dispute between the parties.

In some embodiments, the computerized method may perform a pre-defined number of iterations of the above stages (e.g., five full iterations). In other embodiments, the method may repeatedly and iteratively perform the above stages, until no further response statements are provided by any party, or until no new response statements are provided by any party, or until other pre-defined conditions hold true.

Upon completion of such iterations, the computerized system may generate as output: (a) a list of the undisputed statements; (b) a list of the disputed statements; (c) the concise position of each party with regard to each one of the disputed statements. Optionally, such output may be provided to another unit or entity, or may be further processed, in Stage E of the method; for example, (i) an arbitrator or mediator or judge or third-party attorney or an expert or other person (e.g., retired judge) may enter a ruling on the legal dispute based on said output; or (ii) one or more experts or entities selected by the system may rule on the disagreements that are left; or (iii) a Machine Learning (ML) unit or an Artificial Intelligence (AI) unit of the computerized system may generate an ML/AI based ruling on each one of the remaining dispute points and/or on the entire dispute, based on pre-defined rules and/or based on lookup tables and/or based on analysis that takes into account Natural Language Processing (NLP) of the statements made by each party (e.g., automatic NLP-based analysis of the statements of Party A may indicate that his Response Statement #3 contradicts his Response Statement #7, or that a Response Statement of Party A in a current iteration contradicts another Response Statement that Party A had provided in a previous iteration, or the like; thereby reducing the weight of correctness of such contradicting statements of that party).

Optionally, an Agreement/Disagreement Meter or gauge or other indicator may be generated by the system and may be dynamically updated by the system as the iterations of the method are progressing, to reflect the current level or percentage of agreement or disagreement between the parties. Such metric may optionally be displayed to the parties, or to one of the parties, or to a third party (e.g., judge, arbitrator); or may otherwise be used or outputted by the system. In the demonstrative drawing of FIG. 1, the Agreement/Disagreement Meter is shown on the left side as a pie chart; and the portion of Agreement increases, while the portion of Disagreement decreases, from one iteration to the next or from one stage to the next. For example, in Stage B there may be 10 statements by each party, or 20 statements in total, with only 2 statements being undisputed, corresponding to 18/20 or 90% disagreement; whereas, after one or two iterations of the computerized method, the number of undisputed statements may rise from 2 to 12, and the number of disputed statements may decrease from 18 to 8, corresponding to 8/20 or 40% disagreement. In another example, after a first iteration of the computerized method, there may be 7 disputed statements out of a total of 10 statements made so far by all the parties, corresponding to 7/10 or 70% of disagreement; then, after a second iteration in which 10 additional statements were entered by the parties, there may be 12 disputed statements out of 20 statements made so far, corresponding to 12/20 or 60% of disagreement; and then, after a third iteration in which 8 additional statements were entered by the parties, there may be 14 disputed statements out of 28 total statements, corresponding to 14/28 or 50% of disagreement. In some embodiments, only the percentage value of Disagreement (or, currently disputed statements) may be shown or indicated; or only the percentage of Agreement (or, currently undisputed statements) may be shown or indicated; or, only the percentage of Skipped or Passed statements may be shown; or a combination of two or all of the above-mentioned data-items may be shown or indicated, as separate or discrete values, or as portions of a pie chart or other suitable representation. In some embodiments, once a pre-defined threshold value of Disagreement is reached (e.g., equal to or smaller than N percent of disagreement), and/or once a pre-defined threshold value of Agreement is reached (e.g., equal to or smaller than M percent of agreement), the system may trigger one or more suitable operations; for example, declaring that the dispute has been resolved or mitigated, or outputting a mapped representation of statements and their current status (disputed, undisputed, skipped), or triggering a referral (or a proposal for referral) of the dispute (and/or the list of mapped or grouped statements) to a third party (e.g., arbitrator, mediator, consultant, judge, jury, advisor, system administrator), or generating an output of only the disputed statements or only the undisputed statements or only the skipped statements or a combination of these output components, or performing other pre-defined operations as a result of such threshold value(s) being reached.

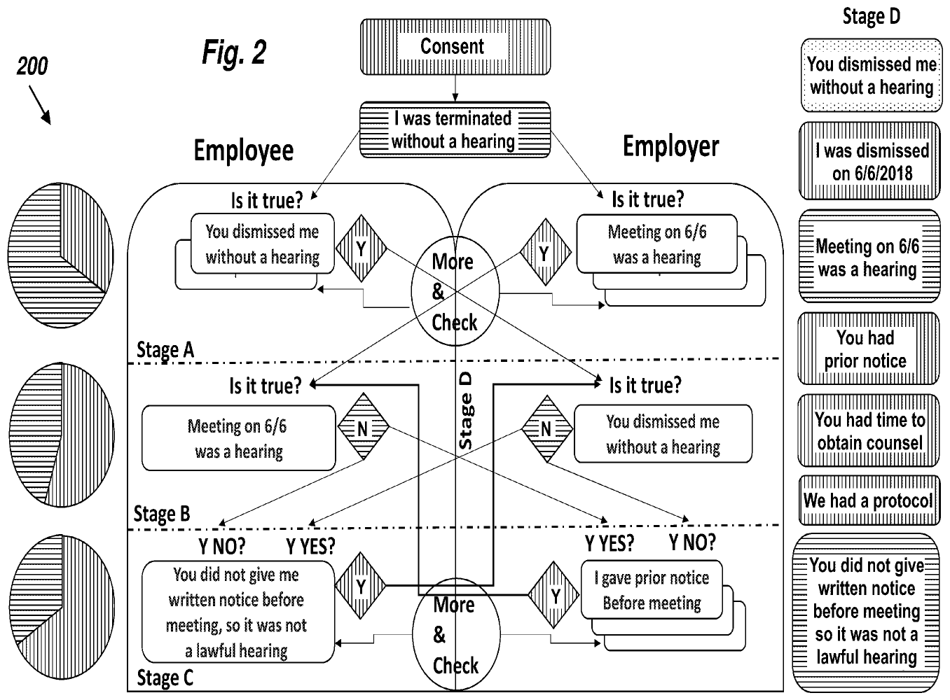

Reference is made to FIG. 2, which is a schematic illustration of a demonstrative computerized method 200 in the context of a labor law dispute or employment law dispute, in accordance with some demonstrative embodiments of the present invention. In this example, the dispute is between Employee (Party A) and Employer (Party B). The Employer has terminated the employment of Employee. The Employee has brought a legal action or claim or complaint or legal dispute against his former Employer. The computerized method and system of the present invention may operate to reduce or mitigate or narrow-down the dispute between the two parties, or to pin-point or otherwise detect the real narrowed-down statements or claims or facts or arguments that are actually the core of the dispute.

The computerized method begins by requesting each one of the two parties to input or to enter, through the computerized system, a set of discrete statements or claims regarding the dispute. The Employee enters a single statement, denoted Statement A1, of “I was terminated on Jul. 15, 2018 without any pre-termination hearing”. The Employer enters a single statement, denoted Statement B 1, of “The Employee was terminated lawfully on Jul. 15, 2018 after a pre-termination hearing was held with the Employee on Jun. 6, 2018”. The computerized system asks the Employee to confirm his own statement, and he does so. The computerized system asks the Employer to confirm his own statement, and he does so. Optionally, the dispute may further include other statements; however, for demonstrative purposes, the discussion herein may focus on the above-mentioned single statement by each party.

The computerized system proceeds by exchanging the statements: the system sends to the Employer a copy of Statement A1 of the Employee, and requests the Employer to respond to Statement A1 with either “yes” (or True, or Correct, or “I agree”), or “no” (or False, or Incorrect, or “I deny”), or “skip” (or “I do not wish to comment on this statement of the other party). In parallel, or simultaneously or concurrently, or shortly thereafter, the system sends to the Employee a copy of Statement B1 of the Employer, and requests the Employee to respond to Statement B1 with either “yes” (or True, or Correct, or “I agree”), or “no” (or False, or Incorrect, or “I deny”), or “skip” (or “I do not wish to comment on this statement of the other party

The Employer responds to Statement A1 of the Employee, by entering an Employer's Response Statement, denoted B2, of “I deny the Employee's statement that he was terminated without a pre-termination hearing, because a pre-termination hearing was held with the Employee on Jun. 6, 2018”. In some embodiments, the system may enforce a pre-defined length (e.g., number of characters and/or number of words) that a statement of a claim may include, such as up to 140 characters per statement, or up to 280 characters per statement, or up to 20 words per statement; or the like; thereby forcing each party to provide his claims in a focused or concise manner, and/or in a manner that enables the other party to efficiently relate to the statement without having to deal with multiple-clause statements or with a complex statement that is partially true and partially false; such that, for example, the above-mentioned Response Statement by the Employer may necessarily be shortened to a more concise version of “A pre-termination hearing was held with the Employee on Jun. 6, 2018”. Similarly, the Employee responds to Statement B1 of the Employer, by entering an Employee's Response Statement, denoted A2, of “I deny the Employer's statement that I was lawfully terminated after a pre-termination hearing, because the meeting that was held on Jun. 6, 2018 was not a pre-termination hearing”. Such statement, too, may be shorter in order to accommodate a pre-defined length limit.

The computerized system proceeds by exchanging the statements: the system sends to the Employer a copy of Statement B2 of the Employee, and requests the Employer to respond to Statement B2 with either “yes” (or True, or Correct, or “I agree”), or “no” (or False, or Incorrect, or “I deny”), or “skip” (or “I do not wish to comment on this statement of the other party), together with a concise textual explanation of his reasoning. In parallel, or simultaneously or concurrently, or shortly thereafter, the system sends to the Employee a copy of Statement A2 of the Employer, and requests the Employee to respond to Statement A2 with either “yes” (or True, or Correct, or “I agree”), or “no” (or False, or Incorrect, or “I deny”), or “skip” (or “I do not wish to comment on this statement of the other party), together with a concise textual explanation of his reasoning.

In other words, the computerized system asks the Employee to clarify, why does the Employee deny the claim that he was terminated without a pre-termination hearing as the Employer alleged that a pre-termination hearing took place on June 6. Concurrently, or simultaneously, or generally in parallel, or shortly thereafter, the computerized system also asks the Employer to clarify, why does he claim that the termination has followed a pre-termination hearing as the Employee denied that a pre-termination hearing took place.

In response to Statement B2 of the Employer, the Employee provides a new response statement, denoted A3, in which he states that a meeting indeed took place on June 6, but further alleges that he did not receive an advance written notice at least 7 days prior to that meeting and therefore that meeting (which indeed took place) cannot be lawfully regarded as a pre-termination hearing.

Similarly, in response to Statement A2 of the Employee, the Employer provides a new response statement, denoted B3, in which he states that the meeting of June 6 was a lawful pre-termination hearing and that an advance written notice about it was given to the Employee on May 25.

The system proceeds to exchange these statements (A3 and B3), and to request each party's reaction or response to the new Statement by the adverse party. For example, in the next iteration, the Employee may submit a new statement (A4) alleging that he has never received the advance written invitation to the pre-termination hearing; whereas, the Employer may submit a new statement (B4) in which the Employer states that a written advance notice for the hearing was indeed handed to the Employee in person on May 25 by hand delivery performed by the Human Resources (HR) manager who is willing to testify about delivering the invitation letter.

As demonstrated, the computerized system has managed to shift or modify or pin-point the dispute between the parties, from an initial dispute about whether or not the entire termination was lawful, to a narrowed-down dispute about the occurrence or non-occurrence of the fact of hand-delivering the written invitation to the meeting to the Employee on May 25. Accordingly, the Agreement/Disagreement Meter of the computerized platform, may dynamically be updated by the system upon each such iteration, indicating a decrease in the Disagreement between the parties from an initial 100 percent, to a later 67 percent, and then to a 42 percent of disagreement.

In some embodiments, optionally, as the iterations proceed, one party or both parties may change their response to a previous statement of the adverse party, from “no” to “skip”, thereby further reducing the disagreement between them, as such previous statement may no longer be relevant or governing with regard to the result of the dispute. For example, a previous statement by the Employer was that a pre-termination hearing took place on June 6; the Employee had previously responded to that statement with “no” (false); but the Employee may later be allowed to modify his previous response from “no” to “skip”, since there is no longer a dispute about the occurrence of a meeting on June 6, but rather, only about the question of whether advance written notice was delivered to the Employee on May 25 regarding that meeting. Such updating of previous statements or response statements that a party had made, may further contribute to the reduction of the disagreement metrics.

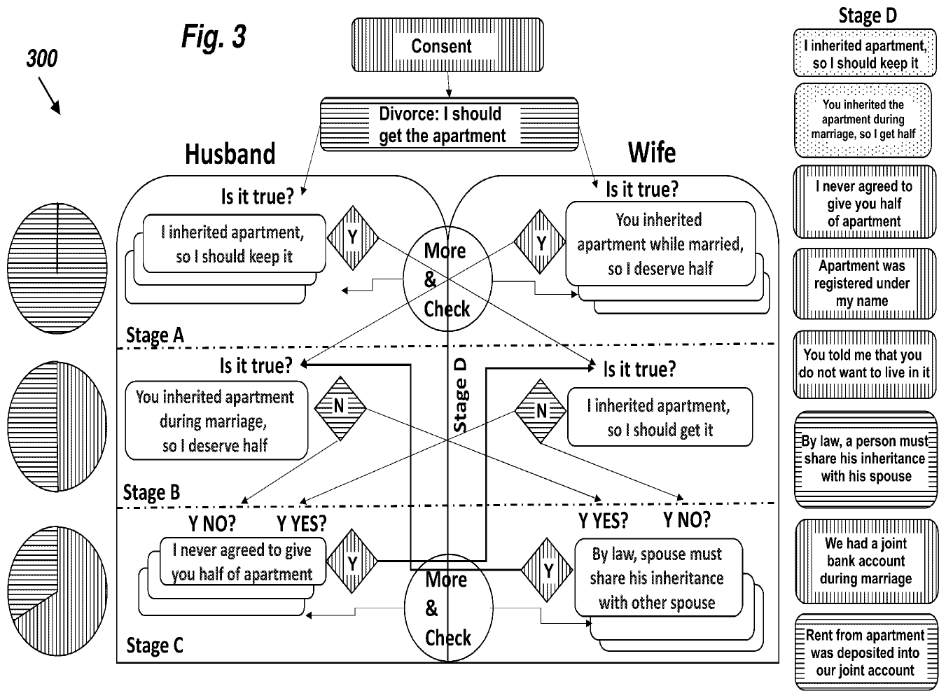

Reference is made to FIG. 3, which is a schematic illustration of a demonstrative computerized method 300 in the context of a family law dispute, in accordance with some demonstrative embodiments of the present invention. In this example, the dispute is between a Wife (Party W) and a Husband (Party H) who are undergoing a divorce or separation process. The Wife has brought a legal action or claim or complaint or legal dispute against her Husband. The computerized method and system of the present invention may operate to reduce or mitigate or narrow-down the dispute between the two parties, or to pin-point or otherwise detect the real narrowed-down statements or claims or facts or arguments that are actually the core of the dispute.

The computerized method begins by requesting each one of the two parties to input or to enter, through the computerized system, a set of discrete statements or claims regarding the dispute. The Wife enters a single statement, denoted Statement W1, of “Wife is entitled to 50 percent of the ownership rights in the Apartment located at 123 Main Street”. The Husband enters a single statement, denoted Statement H1, of “Husband is entitled to the entire 100 percent of the ownership rights in the Apartment located at 123 Main Street”. The computerized system asks the Wife to confirm her own statement W1, and she does so. The computerized system asks the Husband to confirm his own statement H1, and he does so. Optionally, the dispute may further include other statements; however, for demonstrative purposes, the discussion herein may focus on the above-mentioned single statement by each party.

The computerized system proceeds by exchanging the statements: the system sends to the Husband a copy of Statement W1 of the Wife, and requests the Husband to respond to Statement W1 with either “yes” (or True, or Correct, or “I agree”), or “no” (or False, or Incorrect, or “I deny”), or “skip” (or “I do not wish to comment on this statement of the other party). In parallel, or simultaneously or concurrently, or shortly thereafter, the system sends to the Wife a copy of Statement H1 of the Husband, and requests the Wife to respond to Statement H1 with either “yes” (or True, or Correct, or “I agree”), or “no” (or False, or Incorrect, or “I deny”), or “skip” (or “I do not wish to comment on this statement of the other party

The Husband responds to Statement W1 of the Wife, by marking it as “false”, and by entering Husband's Response which comprises four new statements, denoted H2, H3, H4 and H5: Statement H2 is “Husband has inherited the Apartment from Husband's Uncle during the marriage period”; Statement H3 is “Apartment was registered at the land registrar with the Husband's name as the sole owner”; Statement H4 is “Husband has never conveyed to Wife any portion of his ownership in the Apartment”; and Statement H5 is “Wife had told Husband during their marriage that she would never desire to live in the Apartment”. The Husband is requested by the computerized system to confirm the correctness of these new Statements H2 to H5; and he does so.

Similarly, the Wife responds to Statement H1 of the Husband, by marking it as “false”, and by entering Wife's Response which comprises two new statements of her own, denoted W2 and W3: Statement W2 is “According to law an apartment that was inherited by a spouse during a marriage, automatically becomes co-owned by both spouses”; and Statement W3 is “Rental income from the Apartment was deposited, repeatedly, during the marriage, into a joint bank account co-owned by Husband and Wife”. The Wife is requested by the computerized system to confirm the correctness of these new Statements W2 and W3; and she does so.

The computerized system proceeds to send to the Wife a copy of the Husband's new statements (H2 to H5); and in parallel, to send to the Husband a copy of the Wife's new statements (W2 and W3); and to request their reaction or response to each statement as “yes” or “no” or “skip”.

The Husband responds to Statement W2 with “no”, and with a new statement H6 of “The law includes an exception based on the exact date in which the Uncle passed away”; and the Husband responds to Statement W3 with “no” and adds a new statement H7 of “A deposit into the joint bank account was a one-time error. Later deposits of the rental were into a bank account owned only by Husband”.

In parallel, the Wife responds to each one of Statements H2 to H5 of the Husband: the Wife responds with “yes” to Statement H2 (“Apartment was inherited from Uncle during marriage period”); and she responds with “skip” to Statement H3 (“Apartment was registered on the Husband's name at the land registrar”) to indicate that this Statement is irrelevant in her view to the outcome of the dispute; and she responds with “skip” to Statement H4, as she believes that it is irrelevant whether the Husband has positively conveyed ownership to the Wife; and she further responds with “skip” to Statement H5 (that she had expressed no desire to live in the apartment) to indicate that this Statement, too, is irrelevant in her view to the outcome of the dispute. Accordingly, the computerized system recognizes that there is no disagreement between Wife and Husband regarding Statements H2 to H5; however, at this stage of response, Wife has also entered a new Statement, denoted W4, of “Section 17 of the Family Law states that I automatically have rights to fifty percent of the ownership in the inherited apartment”.

The computerized system proceeds to send to each party the new Statements of the other party, to request a response of “yes” or “no” or “skip” for each such statement. The computerized system may indicate that the actual core of the dispute that remains in disagreement, is whether or not the Family Law, and particularly Section 17 of it, give the wife a legal right to the inherited apartment, regardless of the facts that are deemed by both parties as either true or irrelevant (e.g., the Wife expressed no interest in living there; the Rental Income was generally deposited into the Husband's bank account; the apartment was registered under the Husband's name only).

Accordingly, the Agreement/Disagreement Meter of the computerized platform, may dynamically be updated by the system upon each such iteration, indicating a decrease in the Disagreement between the parties from an initial 100 percent, to a later 50 percent, and then to 33 percent of disagreement.

In some embodiments, optionally, as the iterations proceed, one party or both parties may change their response to a previous statement of the adverse party, from “no” to “skip”, thereby further reducing the disagreement between them, as such previous statement may no longer be relevant or governing with regard to the result of the dispute. For example, a previous statement by the Wife was that rental income was deposited into a joint bank account; Husband may initially mark this as “no” (false); and later, in view of the change of focus of the dispute towards the correct construction of Section 17 of the Family Law, the Husband may later be allowed to change his response to that Statement from “no” to “skip” as it is deemed by the Husband as no longer relevant to the outcome of the dispute. Such updating of previous statements or response statements that a party had made, may further contribute to the reduction of the disagreement metrics.

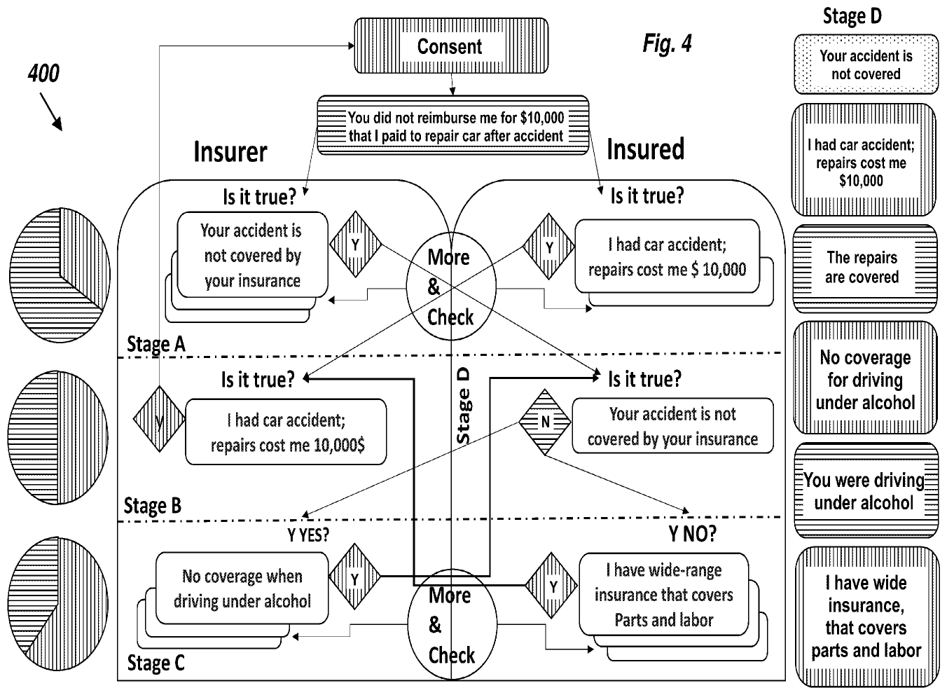

Reference is made to FIG. 4, which is a schematic illustration of a demonstrative computerized method 400 in the context of an insurance law dispute, in accordance with some demonstrative embodiments of the present invention. In this example, the dispute is between an Insured Party (P) who sues an Insurance Company (C) for 10,000 dollars of car damage due to being involved in a car accident. The computerized method and system of the present invention may operate to reduce or mitigate or narrow-down the dispute between the two parties, or to pin-point or otherwise detect the real narrowed-down statements or claims or facts or arguments that are actually the core of the dispute.

The computerized method begins by requesting each one of the two parties to input or to enter, through the computerized system, a set of discrete statements or claims regarding the dispute. The Insured Party enters three statements: Statement P1 of “On April 15 my car was involved in a car accident”; Statement P2 of “I had on April 15 a valid car insurance policy with the Insurance Company”; Statement P3 of “I had to pay 10,000 dollars to the mechanic to fix the damage to my car”; and Statement “P4” of “According to the insurance policy, I am entitled to receive 10,000 dollars from the Insurance Company”. The computerized system asks the Insured Party to confirm his own statements P1 to P4, and he does so.

In parallel, the Insurance Company enters a single Statement C1, of “The insurance policy does not cover the incident which is the subject of this claim”. The computerized system asks the Insurance Company to confirm its own statement C1, and it does so.

The computerized system proceeds by exchanging the statements: the system sends to the Insured Party a copy of Statement C1 of the Insurance Company, and requests the Insured Party to respond to Statement C1 with either “yes” (or True, or Correct, or “I agree”), or “no” (or False, or Incorrect, or “I deny”), or “skip” (or “I do not wish to comment on this statement of the other party). In parallel, or simultaneously or concurrently, or shortly thereafter, the system sends to the Insurance Company a copy of Statements P1 to P4 of the Insured Party, and requests the Insurance Company to respond to each of those statements with either “yes” (or True, or Correct, or “I agree”), or “no” (or False, or Incorrect, or “I deny”), or “skip” (or “I do not wish to comment on this statement of the other party.

The Insurance Company responds with “yes” or with “skip” to Statements P1, P2 and P3 of the Insured Party, as the Insurance Company agrees to them or does not dispute them, or regards them immaterial to the outcome of the dispute. The Insurance Company responds with “no” to Statement P4 of the Insured Party; and adds a new Response Statement, denoted C2, of “The insurance policy excludes coverage if the incident is the Insured Party driving under the influence of alcohol”.

In parallel, the Insured Party responds with “no” to Statement C1 of the Insurance Company; and enters a new Statement, denoted P5, of “The car accident involved me crushing into a tree and this is covered under the insurance policy”.

The computerized system proceeds to send to each party, the statements or response of the other party, and to obtain their fresh responses. For example, the Insured Party may respond with “skip” to the Statement C2, and may enter a new Statement P5 of “A police report authored by Policeman James at the scene of the accident determined that I was not driving under the influence of alcohol”.

In parallel, the Insurance Company may respond with “yes” or with “skip” to some or all of the outstanding Statements of the Insured Party; and the Insurance Company may enter a new Statement, denoted C3, of “The hospital report states that the blood alcohol level (BAC) of the Insured Party twenty minutes after the accident was 0.15 percent”.

The computerized system may thus continue to enable timed exchange of those Statements between the two parties, and to obtain each party's reaction or response to each statement (or response) by the other party. Accordingly, the computerized system is able to narrow-down the actual core of the dispute to a pin-point question of whether or not the Insured Party was driving under the influence of alcohol at the time of the accident; with the Insurance Company relying on a Hospital Report for a positive answer to that question, and with the Insured Party relying on a Police Report for a negative answer to that question.

It is noted that the computerized system was able to successfully “remove from the table” or discard various or even numerous Statements, that were made by one party or by both parties, which are actually not in disagreement; such as, the statement that a car accident has occurred, or the statement that a valid car insurance policy was in force at that time, or the statement that the Insured Party has indeed paid 10,000 dollars to a car mechanic to fix the damage to the car, and so forth. These operations of reduction or discarding may, by themselves, contribute to the ability of the parties to clearly see what the real issue in dispute is, and further enables the system to pin-point and detect such specific issue.

Accordingly, the Agreement/Disagreement Meter of the computerized platform, may dynamically be updated by the system upon each such iteration, indicating a decrease in the Disagreement between the parties from an initial 100 percent, to a later 75 percent, and then to 40 percent of disagreement.

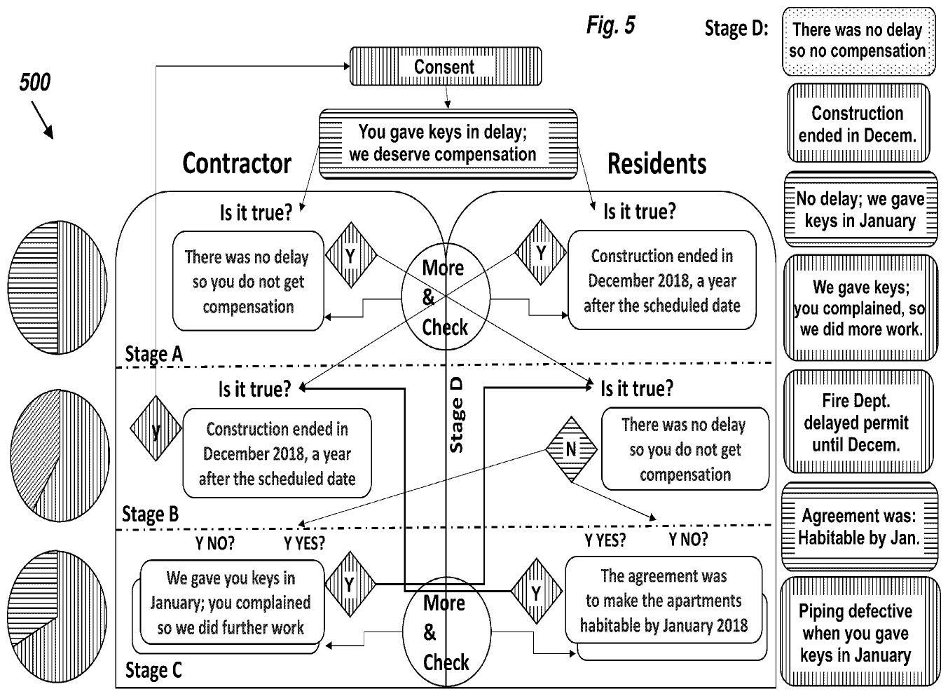

Reference is made to FIG. 5, which is a schematic illustration of a demonstrative computerized method 500 in the context of a real estate law dispute or a construction law dispute, in accordance with some demonstrative embodiments of the present invention. In this example, Residents (Party R) of an apartment building are suing the contractor the builder (Party C), claiming that they should have received the keys for their new apartments in January 2018, whereas they received the keys only in December 2018. The contractor claims there was no delay because the keys were given to the Residents in January 2018.

The computerized system prompts each party to enter his claim; and asks each party to confirm the correction of his claim. The system asks each party to add further claims, but for demonstrative purposes, the discussion herein may focus on a single claim or clause.

Each party receives via the system a copy of the other party's claims, and is asked to respond with “yes” or “no” or “skip”.

In a first iteration, the contractor agrees that the construction indeed ended 11 months after the agreed scheduled date; and the residents deny that this there was no delay in receiving the keys to the apartments.

The system then proceeds to asks the residents why they deny that there was no delay; and in parallel, the system asks the contractor why he claims that there was no delay.

In the next iteration, the Contractor enters three new claims or Statements: that he gave the residents the keys in January 2018 but because they complained he performed further repairs; and that there was no delay because they physically received the keys in January 2018 as scheduled; and that the Fire Department did not provide the necessary permits until December 2018. In parallel, the Residents provide to the system two claims: that the original contract was to make the apartments habitable by January 2018; and that the building's piping system was not functioning when they received the keys in January 2018.

Meanwhile the “Agreement/Disagreement Meter” of the computerized platform indicates the increase in agreements and/or the reduction in disagreements, from 50% disagreement, to 43% disagreement. Based on the exchanging of statements and responses, the two parties are able to understand that the actual dispute is about whether the contractor had to deliver the apartments ready for living in January 2018, and whether he was required to complete the piping system in the building by that date. Therefore, the parties may change their reply to the first question to “skip”, because it has become irrelevant; and the disagreement rate may further decrease to 28%.

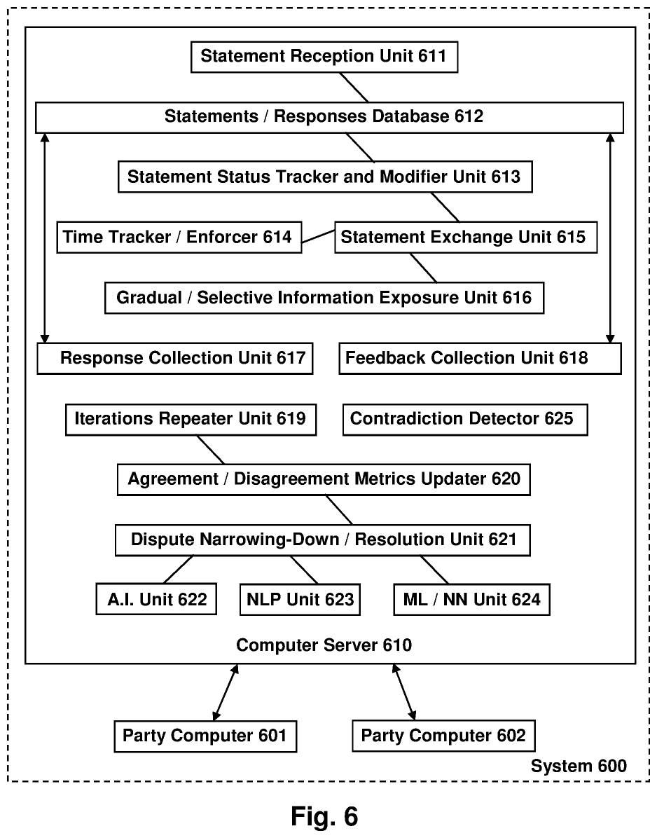

Reference is made to FIG. 6, which is a schematic block-diagram illustration of a computerized system 600, in accordance with some demonstrative embodiments of the present invention. System 600 may comprise, for example, a Server Computer 610, able to communicate via wireless communication link(s) and/or via wired communication link(s) and/or via Internet-based communication with computing devices or two or more parties to a dispute, such as, Party Computer 601 and Party Computer 602. Each one of the computers (601, 602, 610) may comprise suitable hardware components and software components, for example, a processor able to execute code or programs, a short-term or volatile memory unit, a long-term or non-volatile storage unit, an input unit (e.g., keyboard, touch-screen, mouse, touch-pad), an output unit (e.g., screen, touch-screen), a power source, an Operating System (OS), drivers, software applications or “apps”; one or more wired transceivers and/or wireless communication transceivers (e.g., Wi-Fi transceiver; Bluetooth transceiver; cellular transceiver); and/or other suitable components. For demonstrative purposes, components 601 and 602 are described as “computers”; however, they may actually be or may comprise other suitable electronic devices or computing devices, for example, a smartphone, a tablet, a smart television, a computing terminal, an electronic device having a screen, a portable electronic device, or the like.

Server Computer 610 may comprise a statement reception unit 611, which is configured to receive a first set of initial statements (S1) from a first entity (E1) through its Party Computer 601; and to further receive (e.g., generally in parallel, or during the same pre-defined time-frame or time-window) a second set of initial statements (S2) from a second entity (E2) through its Party Computer 602. The first and second sets of initial statements (S1, S2) pertain to a same disputed subject-matter. In some embodiments, each party provides to Server Computer 610 his own statement, without yet seeing or having access to the statements that the other party is currently entering and/or has already entered in the same iteration.

Statements entered by each party are stored in a Statements/Responses Database 612, in the Computer Server 610 and/or within another unit (e.g., optionally implemented as a remote repository or as a cloud-based repository or database). Each content-item stored in the Statements/Responses Database 612 is tagged or marked with, or is associated with, a time-stamp/date-stamp indicating the time and date of its entry; as well as other meta-data, such as an identifier of the party who provided or entered such statement or response, or other meta-data indicating the exact stage or iteration within the process in which such statement or response was entered (e.g., “an initial statement”, or “a new non-initial additional statement”, or “a True/False/Pass response to an adversary's statement”, or “a response statement made in response to a statement of the other party”, or other suitable tags or identifiers).

A Statement Status Tracker and Modifier Unit 613 operates to dynamically track and update the status and/or tags of each Statement or other content-item that is stored in the Statements/Responses Database 612, to reflect the current status of this statement out of a set of pre-defined status types; for example: indicating that Statement number 17 is “an initial statement of Party 1 to which Party 2 has not yet provided his response”; or indicating that Statement number 14 is “a statement by Party 1 that Party 2 has already agreed with a True reaction” and thus Statement number 14 is marked as an Agreed Statement; or indicating that Statement number 12 is “a statement by Party 1 to which Party 2 has most-recently responded to with False” and thus Statement number 12 is currently a Disagreed Statement or a Disputed Statement; or indicating that Statement number 8 is “a statement by Party 2 to which Party 1 has already responded with a Pass reaction” and thus Statement number 8 is tagged, uniquely, as an Agreed Statement or as a non-disputed statement even though Party 1 has not explicitly expressed his consent to the correctness or truthfulness of such statement; or the like.

The content stored in the Statements/Responses Database 612 may optionally be encrypted, using an encryption key that is known to the administrator of system 600 and/or to the administrator of Computer Server 610, while not being known to Party 1 or to Party 2 or to the end-user Party Computers 601-602. Accordingly, system 600 operates such that each one of Party Computer 601 and Party Computer 602 is selectively exposed only to a subset of the data stored in Statements/Responses Database 612 with regard to the dispute; and/or such that each party gains gradual access to additional data only at pre-defined time-points or mile-stones during the dispute resolution process, and not in real-time as adverse statements are entered into the system by the other party; thereby enforcing a rule that each party is obligated to provide his own Statements or positions, while knowing what are the statements or positions that the adverse party has provided until the most-recent iteration but not yet during the current iteration. Optionally, a Gradual/Selective Information Exposure Unit 616 may operate to enforce such selective and gradual exposure of statements or content-items to each relevant party, and may enforce the above-mentioned rule by hiding from Party 1 content-items that Party 2 has already entered only a few minutes ago during the same iteration, while also making available to Party 1 the previously-made statements that Party 2 had made during previous iterations but not in the same current iteration that is still ongoing for Party 1 entry of statements. It is clarified that the gradual exposure or gradual hiding of information or statement(s) may be an optional feature; such that in some embodiments, a statement or a response that was provided or entered by Party A, is immediately exposed to Party B or is immediately made available by the system to Party B to further respond to it, and so forth. In some embodiments, a system administrator or an entity that acts as a “dispute manager” (arbitrator, mediator, judge, consultant, third party) may define in advance (or, dynamically during the dispute) the number of parties to the dispute and/or the percentage of those parties that need to respond to a statement before such statement becomes available for other parties to view and/or before such statement (and the responses to it by parties) becomes available to all the parties or to the adverse parties. In some embodiments, optionally, the system may be configured such that when two parties are involved, Party A submits a new statement, and immediately upon such submission, this statement is immediately available for Party B to view and to respond to. In other embodiments, optionally, the system may be configured such that when two parties are involved, Party A submits a new statement, and that new statement is not yet available for viewing by (or for responding by) Party B until or unless a pre-defined condition holds true (e.g., until Party B provides a new statement of his own; or, until Party B provides his responses to at least 50% of the statements that are already available for him to respond to and that are waiting for his response). Other suitable conditions may be used.

A Time Tracker/Enforcer Unit 614 operates to allocate a time-period for completion of each iteration of the method, and/or to track the passage of time that is allocate for each iteration of the method, and/or to enforce the allocated time-period(s) for each iteration and/or for a batch or group of iterations and/or for the entire dispute resolution process. For example, the Time Tracker/Enforcer Unit 614 may allocate and enforce a time-period of 72 hours from commencing of an online dispute resolution process, for each party to provide his initial Statements; and then, may allocate and enforce a time-period of 96 hours for each iteration of the dispute resolution process; or may allocate and enforce a total aggregate of 15 days for an entire dispute resolution process; or the like. In some embodiments, the Time Tracker/Enforcer Unit 614 may allocate time-periods and may enforce them, based on a lookup table or based on a set of pre-defined rules that may take into account, for example, the number of involved parties (two, or more than two); their geographic location (e.g., in the same time-zone or country, or in different time-zones or countries), whether or not each party is represented by an attorney, the type of the dispute involved (e.g., enforcing a first time schedule for a dispute in Employment Law, and a second, different, time schedule for a dispute in Family Law), and/or other suitable parameters or conditions or considerations.

In some embodiments, optionally, Computer Server 610 may perform one or more actions once the allocated time-period has elapsed, if one of the parties did not complete his responses; for example, by marking each Statement of Party 1, that Party 2 did not respond to (within the allocated time-frame), as an Undisputed Statement or as an Agreed Statement. In some embodiments, system 600 may enforce a penalty upon a party that failed to act or to fully act within the allocated time-frame; such as, by marking a statement of his adversary as True or undisputed, or by reducing the number of Statements that the non-acting party is allowed to mark as False and/or as Pass, or the like.

A Statement Exchange Unit 615 operates to send to the second entity (E2) a copy of the first set of initial statements (S1), and to send in parallel to the first entity (E1) a copy of the second set of initial statements (S2). The sending may be performed by one or more suitable ways; for example, via electronic mail (email), via text messages or instant messages, via a dedicated application or “app” or mobile application, via a web-based platform or website that each party has to utilize and has to log-into for the purpose of entering his input and/or receiving and consuming content (statements, responses) that was entered by the other party, or the like.

A Response Collection Unit 617 operates to collect from the first entity (E1) a first set of discrete responses (R1) to each one of the initial statements in the second set of initial statements (S2), wherein each response from the first entity (E1) is either True or False or Pass. The Response Collection Unit 617 further operates to collect, generally in parallel, from the second entity (E2), a second set of discrete responses (R2) to each one of the initial statements in the first set of initial statements (Si), wherein each response from the second entity (E2) is either True or False or Pass. In accordance with the present invention, the response of each party to each statement of his adversary, is constrained to only one out of only three possible responses (True, False, Pass; or True, False, Skip); as the Applicants have realized that this unique configuration may be particularly beneficial for advancing the dispute towards resolution and/or towards narrowing-down of the disputed points and/or towards detecting the actual core of disagreement between the parties.

A Feedback Collection Unit 618 operates after the first set of responses (R1) is received from the first entity (E1) and after the second set of responses (R2) is received from the second entity (E2). For example, the feedback collection unit 618 collects from the first entity (E1) a first set of additional statements (A1) only with regard to False response statements (R2) of the second entity (E2). Similarly, the feedback collection unit 618 collects from the second entity (E2) a second set of additional statements (A2) only with regard to False response statements (R1) of the first entity (E2).

Furthermore, in some embodiments, the response collection unit 618 collects from the first entity (E1) another set of discrete responses (RR1) to each one of the additional statements (A2) of the second entity (E2), wherein each response (RR1) from the first entity (E1) is either True or False or Pass. Similarly, the response collection unit 618 collects from the second entity (E2) another set of discrete responses (RR2) to each one of the additional statements (A1) of the first entity (E1), wherein each response (RR2) from the second entity (E1) is either True or False or Pass.

An Iterations Repeater Unit 619 may operate to repeat, in an iterative manner, the steps of the computerized process in which statements are collected from each party, and are sent to the adverse party for response; and such that the responses collected are utilized in order to update the current Status of each Statement in the dispute, and to reflect whether it is currently regarded as a “disputed” item or as an “undisputed” item. The update of the status may be performed by the Statement Status Tracker and Modifier Unit 613 mentioned above; while the Iterations Repeater Unit 619 operates to enforce a repetition of the above-mentioned steps with regard to newly-added statements or responses, up until a pre-defined condition holds true; such as, until a pre-defined number of iterations and/or statements has been reached, or until the number of discrete statements that are still in dispute is smaller than a pre-defined threshold value or percentage value (out of all the statements entered in the dispute), or until one (or more) of the parties indicates his desire to stop the computerized process, or based on other suitable criteria or conditions.

An Agreement/Disagreement Metrics Updater 620 operates to dynamically calculate and update, and to optionally also display to each party and/or to the system administrator, one or more metrics or statistics or analytics data with regard to the progress of the dispute; for example, the absolute number of Statements entered so far by Party 1; the absolute number of Statements entered so far by Party 2; the absolute number of Statements entered so far in aggregate by all parties; the number of Statements that are currently undisputed, and their percentage out of the total number of statements; the number of Statements that are currently disputed, and their percentage out of the total number of statements; indication of whether the trend of disagreement is a trend of increase in disagreement or is (more likely, in many scenarios) a trend of decreasing disagreements; the number of statements of Party 1 that are currently disputed by Party 2, and their percentage out of all the statements made by Party 1; the number of statements of Party 2 that are currently disputed by Party 1, and their percentage out of all the statements made by Party 1; the elapsed time within the dispute resolution process and/or within the currently-ongoing iteration; the remaining time for the entire dispute resolution process and/or for the currently-ongoing iteration; or the like.

The Agreement/Disagreement Metrics Updater 620 may generate output in one or more suitable formats, for example, as textual output (e.g., “more than half of the original statements are currently undisputed”), as numeric output or as numeric and textual data (e.g., “disagreement meter=33%”), as a graphical representation (e.g., a pie chart representation indicating 25 percent of disagreement and 75 percent of agreement), a graph indicating the trend and/or the historic values of disagreement percentage (e.g., visually indicating a disagreement decrease trend from initial 100% disagreement, to subsequent 75% disagreement, to current 40% disagreement), or the like.

A Dispute Narrowing-Down/Resolution Unit 621 may operate to process said initial statements (S1, S2) and responses (R1, R2) and additional statements (A1, A2) and additional responses (RR1, RR2) generate an output indicating a narrowed-down description of said dispute relative to the initial statements (S1, S2). The narrowed-down core of the dispute may be generated at a pre-defined time-point that was scheduled to be the resolution time-point; or once the level of disagreement is below a pre-defined threshold value (e.g., less than 50 or 33 or 25 or 20 percent of disagreement), or once a pre-defined condition holds true (e.g., in some embodiments, if one or more of the parties has reached a limit or a quota of statement that he is allowed to provide to the system and is thus not allowed to provide further inputs to the system, hence an output may be generated). In some embodiments, optionally, Dispute Narrowing-Down/Resolution Unit 621 may be able to generate a dispute resolution, with regard to the entire dispute, and/or with regard to one particular point of disagreement, or with regard to some (but not all) points of disagreement; for example, by using one or more of the AI algorithms or ML algorithms or NN units or contradiction detection operations that are described above and/or herein.

In some embodiments, system 600 and/or its components, and particularly the Computer Server 610, are configured to implement or execute a computerized method of dispute resolution or dispute mitigation or dispute narrowing-down. In some embodiments, the method comprises: (a) receiving from two parties to a dispute, textual statements that define each party positions with regard to the dispute; (b) sending to each party a copy of the textual statements of the other party, and obtaining from each party responses to each textual statement sent to him, wherein each response is a selection among True or False or Pass, wherein the responses are collected from a first party before the first party receives a copy of the responses of the second party; (c) receiving from said two parties additional textual statements with updated positions with regard to said dispute; (d) iteratively performing steps (b) and (c) with regard to statements and responses, until a pre-defined condition holds true; (e) based on analysis of said textual statements and responses, generating a textual description of a pin-pointed core of said dispute; wherein the computerized method is implemented by at least a hardware processor.

In some embodiments, step (d) comprises: iteratively performing steps (b) and (c) with regard to statements and responses, for a pre-defined number of iterations.

In some embodiments, step (d) comprises: iteratively performing steps (b) and (c) with regard to statements and responses, for a pre-defined time-period.

In some embodiments, step (d) comprises: iteratively performing steps (b) and (c) with regard to statements and responses, and in parallel tracking a percentage of disagreed positions of said parties, until said percentage of disagreed positions is smaller than a pre-defined threshold value.

In some embodiments, step (e) comprises: tagging as True any particular response statement of any of said two parties, that was marked as Pass by at least one of said two parties; and counting said particular response statement as a position that is agreed by both of said two parties. This may be performed, for example, by the Statement Status Tracker and Modifier Unit 613.

In some embodiments, the method may further comprise: enforcing a pre-defined constraint on the number of times that a particular party can respond with Pass, within a single iteration of statements.

In some embodiments, the method may further comprise: enforcing a pre-defined constraint on the number of times that a particular party can respond with Pass, within a batch of multiple iterations of statements.

In some embodiments, the method may further comprise: enforcing a pre-defined constraint on the number of statements that a particular party can enter within a single iteration of said computerize method.

In some embodiments, the method may further comprise: enforcing a pre-defined constraint on the number of statements that a particular party can enter within a batch of multiple iterations of said computerize method.

In some embodiments, step (e) comprises: generating an output of narrowed-down dispute points, which comprises: (i) all statements made by the first party, to which the second party responded with False; and (ii) all statements made by the second party, to which the first party responded with False; wherein said output of narrowed-down dispute points excludes any statements made by either party, to which the response of the other party was either True or Pass. In some embodiments, optionally, the output generated by the system may include a list of all the statements made by all the parties, with an indication whether each one of these statements (i) is agreed by all the parties, or (ii) is disputed by at least one of the parties, or (iii) was marked as Skip/Pass by one of the parties or by both parties. In some embodiments, each statement in the least may be accompanied by indicators of the number of parties, or the percentage of parties, that agreed to it, or that disputed it, or that skipped it. In some embodiments, the system may enable a user to filter or sort the list of statement, to show only the statements that are still in dispute, or to show only the statements that were skipped, or to show only the statements that are no longer in dispute; or to search for statements based on multiple conditions and/or Boolean operators (e.g., implementing a query of “show me all the Statements made by Party B, to which Party A responded with Skip”, or a query of “show me all the Statements made by Party A, which were disputed by Party B”).

In some embodiments, the method may further comprise: applying an Artificial Intelligence (AI) dispute resolution algorithm, that parses: (i) all statements made by the first party, to which the second party responded with False; and (ii) all statements made by the second party, to which the first party responded with False; wherein said AI dispute resolution algorithm generates a decision on said dispute based on said parsed statements.

Optionally, the above-mentioned operations or some of them, or some of the operations discussed herein, may be performed via an AI unit 622 or AI engine or AI processor, optionally utilizing a Natural Language Processing (NLP) unit 623 to comprehend the content and/or context of each Statement and to assess its internal correctness relative to itself and/or to assess its external correctness relative to other statement(s) made by the same party.

Optionally, a Machine Learning (ML)/Neural Network (NN) unit 624 may be used; for example, to train a NN with a large set of Statements made by parties to legal dispute (e.g., “I paid my debt”, and “The debt calculation is wrong”, and “I acted in accordance with the contract”, and “I did not receive the advance written notice that I deserved”, and “The other party did not perform his obligation by the agreed date”, and “The other party failed to disclose a pertinent face”), with the correct legal result or the appropriate legal result of various combinations of legal statements and/or facts. For example, in some embodiments, manual and/or machine-based analysis may be performed, to analyze a corpus of legal disputes that are reflected in actual legal cases that were argued, decided, and published; to extract from such documentation the various statements and the decision by the judge or jury or court; and to thereby train the ML/NN unit 624 that such combination of statements should be associated with a particular legal outcome; thus enabling such ML/NN unit 624 to autonomously generate a suitable outcome based on a current collection of Statements, or based on a current collection of Undisputed Statements, or based on a current collection of Disputed Statements and Undisputed Statements. In a demonstrative example, the NN may be trained to identify that when Party 1 makes ten different statement about a Debt to him, and then Party 2 makes a statement of “The debt was created 13 years ago and therefore the Statute of Limitations bars the collection of this debt”, and then Party 1 does not dispute (or, agrees to, or “passes” on) that particular statement, then the legal outcome is and should be that the alleged Debt cannot be collected any more by Party 1; and the ML/NN unit 624 may be able to identify similar situations in other disputes, and to generate the respective outcome accordingly.

Accordingly, in some embodiments, the computerized method includes: (I) training a Neural Network (NN) Unit with a training-set which comprises data-items describing a plurality of legal disputes, wherein for each legal dispute the training-set comprises at least (i) statements made by a first party, and (ii) statements made by a second party, and (iii) a court-decided outcome of the legal dispute; and then, (II) generating a fresh outcome to said dispute between said two parties, by feeding to said NN Unit a collection of disputed statements and undisputed statements of said two parties, and generating by said NN Unit a dispute outcome.

In some embodiments, the Artificial Intelligence (AI) dispute resolution algorithm may parse: (i) all statements made by the first party, to which the second party responded with False; and (ii) all statements made by the second party, to which the first party responded with False. The AI dispute resolution algorithm may utilize a Contradiction Detector 625, which detects a cross-statement contradiction (or inconsistency, or mismatch, or misalignment) between two or more statements made by the first party (e.g., “I never agreed to buy the car”, and later “I agreed to buy the car for 4,000 dollars and not for 6,000 dollars”), or which detects an internal contradiction (or inconsistency, or mismatch, or misalignment) within a single statement of a parry (e.g., a single statement of “I do not owe money for this car because I never agreed to buy it and I already paid 5,000 dollars for this car”). The AI dispute resolution algorithm may then generate a decision on said dispute based on said parsed statements and based on said internal contradiction or cross-statement contradiction.

In some embodiments, each iteration of steps (b) and (c) is performed within a pre-defined time-period that is allocated and enforced; wherein within each current iteration, the computerized method hides from the first party, new responses and new statements that the second party already provided during said current iteration. Within each current iteration, the computerized method hides from the second party, new responses and new statements that the first party already provided during said current iteration.

In some embodiments, upon each iteration of steps (b) and (c), an on-screen agreement/disagreement meter is dynamically updated to reflect a current percentage of currently-disagreed statements out of an entirety of statements that were provided so far by said parties.

In some embodiments, once the current percentage of currently-disagreed statements is below a pre-defined threshold value, said computerized method comprises triggering a dispute resolution unit to automatically generate a resolution with regard to said dispute based on evaluation of the statement made by said parties.

In some embodiments, upon reception of a party response of Pass, towards a previous statement that was made by the other party, the computerized method marks said previous statement as a statement that is no longer in dispute between the two parties even though said party did not explicitly mark said previous statement as an agreed statement.

In some embodiments, upon reception of a party response of either True or Pass, towards a previous statement that was made by the other party, the computerized method marks said previous statement as a statement that is no longer in dispute between the two parties.

In some embodiments, said two parties to said dispute are a single entity which provides statements for and against a decision that said single entity has a dilemma about; and the computerized method operates to enable said single entity to resolve said dilemma based on mapping of statements related to said dilemma.

In some embodiments, the method may comprise: generating a mapped dispute overview, which comprises: (i) a first output with all statements that are currently disputed, (ii) a second output with all statements that are currently undisputed, (iii) a third output with all statements that at least one party has responded to with Pass; and optionally, generating a proposal to refer disputed statements to one or more dispute resolving entities. The output generation may optionally be performed by a dedicated unit or module, such as by a Dispute Mapping Unit or a Dispute Mapper, or by a Statement Mapping Unit or a Statement Mapper, which may operate to analyze and/or determine the exact current status of each statement based on the input(s) received about it from the parties involved; for example, operating to determine that Statements number 1 and 4 are currently in dispute (in disagreement), and that Statements number 2 and 5 are currently undisputed (in agreement), and that Statements number 3 and 6 were Skipped or Passed by at least one party; thereby generating a representation of a “statements map”, or a sorted or grouped data-set of the statements based on their current status, thus enabling each party to the dispute and/or a third party (e.g., mediator, arbitrator, judge, jury, consultant, observer, system administrator) to rapidly and efficiently view and understand which statement(s) are currently in dispute and/or which statements were already agreed or are undisputed and/or which statements were skipped or passed.

Some embodiments may comprise other and/or additional steps or operations.

In some embodiments, the computerized system may identify or detect that a particular party is no longer interested in continuing with the computerized method for dispute resolution or for dispute mitigation. For example, the system may generate a “pop-up notification” after every “Skip” response of Party A, to verify that he is indeed interested in skipping, and/or to request him to re-consider his response and check whether he can help mitigate the dispute by responding in Yes (True) or No (False). Then, once Party A has entered a pre-defined number of Skip responses (e.g., in total so far; or consecutively in series), the system may determine that Party A is not interested in responding, and may take one or more actions; for example, (i) enforcing a sanction against Party A who skipped an excessive number of statements, or (ii) enforcing a sanction against Party B because his statements cause inability or reluctance to provide a Yes/No response to them, or (iii) generating a notification to Party B to re-phrase one or more statements that Party A has skipped such that re-phrased statements may trigger a Yes/No response from Party A rather than a Skip response; or the like.

In some embodiments, the computerized system may show to each party, at any given point in time, a list of all the Statements made so far by the parties, together with indications (e.g., color indications, color codes, arrows pointing Up or Down, or other visual effects) to indicate whether each statement is in dispute or is in agreement or was Skipped by one of the parties; and further enabling each party to filter or sort or search such Statements using queries and/or using Boolean operators (e.g., “Show me all the Statements made by Party A, that include the word ‘Rent’, and that Party B is disputing”).

In some embodiments, optionally, the list or database of such Statements, together with their status indicators (in dispute, or agreed, or skipped) may further be available via the computerized system to one or more third parties; for example, to an arbitrator or a mediator or a judge or a jury or other third-party that was designated or selected to resolve or mitigate or arbitrate or mediate the dispute or to decide on the dispute. In some embodiments, such third-party may be only a silent spectator, and may not be authorized to add his input into the list of statements. In other embodiments, optionally, the computerized system may enable such third party to be an active participant in the management of the dispute, and/or may enable the third party to add his own comments or questions or queries or suggestions, which may be added into the list of Statements, and which may trigger responses from the parties or may not necessarily require the parties to respond to them; for example, a third party mediator may add his own Statement of “Suggesting to the parties to focus on the actual monetary damage from the accident, rather than on damages for pain and sorrow”, or may add a Statement of “Suggesting the parties to re-consider their responses to Statement Number 17 in view of Section 105 of the Companies Law”, or the like. In some embodiments, review of the dispute by such party, or accompanying the dispute by such third party, may be implemented as a premium feature which may be available subject to a fee or subject to an additional fee.

In some embodiments, the computerized system may further enable some disputes, such as upon the consent of the two parties involved, to be open for review by the general public (e.g., similar to the manner in which civil litigation is often open to the public in a courthouse), and/or to be open for review by one or more pre-defined experts or consultants in a particular field (e.g., an expert in Labor Law, an expert in Companies Law, or the like). Optionally, such third party may provide suggested feedback as additional statements from him, that the two parties to the dispute may view; or, such third party may provide his feedback or his advice (e.g., in a secured channel) only to one of the parties who requested his feedback with regard to the ongoing dispute. In some embodiments, the review of the dispute by such third party, or his feedback or advice, may be implemented as a premium feature which may be available subject to a fee or subject to an additional fee.

For demonstrative purposes, portions of the discussion herein may relate to a dispute between two (or more) parties or entities or persons; however, some embodiments of the present invention, as well as the computerized system and computerized method of the present invention, may similarly be used in conjunction with resolving or mitigating a same-person or single-person dilemma or internal dispute or internal conflict or internal hesitation with regard to a question or problem. For example, a single user Adam may utilize the computerized system of the present invention in order to mitigate or resolve an internal dilemma of whether or not he should quit his current job; by providing to the computerized system a list of statements that support the quitting, then “responding” to them with counter-arguments or counter-statements that oppose the quitting, then adding new statements or new arguments as well as responses (Yes, No, Skip) with regard to previously-raised statements. Optionally, such process may be performed by a single person or by a single entity, over a single session or over multiple sessions or multiple days, thereby enabling the particular statements to “sink in” with that person and enabling him to re-evaluate the correctness or the strength of the his own previously-made statements or arguments, and enabling him to efficiently manage “pro” and “con” arguments with regard to his dilemma or problem.

Some embodiments of the present invention may be implemented by using hardware components, software components, a processor, a processing unit, a processing core, a controller, an Integrated Circuit (IC), a memory unit (e.g., RAM, Flash memory), a storage unit (e.g., Flash memory, hard disk drive (HDD), sold state drive (SSD), optical storage unit), an input unit (e.g., keyboard, keypad, touch-screen, microphone, mouse, touch-pad), an output unit (e.g., monitor, screen, audio speakers, touch-screen), wireless transceiver, Wi-Fi transceiver, cellular transceiver, power source (e.g., rechargeable battery; electric outlet), an Operating System (OS), drivers, applications or “apps”, and/or other suitable components.

In some implementations, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Although portions of the discussion herein relate, for demonstrative purposes, to wired links and/or wired communications, some implementations are not limited in this regard, but rather, may utilize wired communication and/or wireless communication; may include one or more wired and/or wireless links; may utilize one or more components of wired communication and/or wireless communication; and/or may utilize one or more methods or protocols or standards of wireless communication.

Some implementations may utilize a special-purpose machine or a specific-purpose device that is not a generic computer, or may use a non-generic computer or a non-general computer or machine. Such system or device may utilize or may comprise one or more components or units or modules that are not part of a “generic computer” and that are not part of a “general purpose computer”, for example, cellular transceiver, cellular transmitter, cellular receiver, GPS unit, location-determining unit, accelerometer(s), gyroscope(s), device-orientation detectors or sensors, device-positioning detectors or sensors, or the like.

Some embodiments may be implemented as (or, by utilizing) a “cloud computing” service or server(s) or repository; or may be provided to customers, clients, subscribers, logged-in users, authorized users, or other types of users via a Web-based interface, and/or via a Web browser, and/or may be provided as a “Software as a Service” implementation. In some embodiments, an entirety of the system may be cloud-based, and may be accessed via a “thin” end-user device or terminal or Web browser. In other embodiments, at least some units (but not necessarily all the units) of the system may be implemented as cloud-based units or services; for example, by utilizing a cloud-based provider to perform the Machine Learning (ML) operations, to run the Neural Network, to perform OCR or image analysis or computerized vision, to generate permutations and/or combinations of components of prior ads, and/or to generate one or more new ads or new ad candidates.

Some implementations may utilize an automated method or automated process, or a machine-implemented method or process, or as a semi-automated or partially-automated method or process, or as a set of steps or operations which may be executed or performed by a computer or machine or system or other device.

Some implementations may utilize code or program code or machine-readable instructions or machine-readable code, which may be stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Cobol, Fortran, ActionScript, AJAX, XML, JSON, Lisp, Eiffel, Verilog, Hardware Description Language (HDL), Register-Transfer Level (RTL), BASIC, Visual BASIC, Matlab, Pascal, HTML, HTMLS, CSS, Perl, Python, PHP, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Furthermore, repeated use of the phrase “in one embodiment” does not necessarily refer to the same embodiment, although it may. Similarly, repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some implementations may be used in, or in conjunction with, various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, a tablet, an on-board device, an off-board device, a hybrid device, a vehicular device, a non-vehicular device, a mobile or portable device, a consumer device, a non-mobile or non-portable device, an appliance, a wireless communication station, a wireless communication device, a wireless Access Point (AP), a wired or wireless router or gateway or switch or hub, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), or the like.

Some implementations may be used in conjunction with one way and/or two-way radio communication systems, cellular radio-telephone communication systems, a mobile phone, a cellular telephone, a wireless telephone, a Personal Communication Systems (PCS) device, a PDA or handheld device which incorporates wireless communication capabilities, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some implementations may comprise, or may be implemented by using, an “app” or application which may be downloaded or obtained from an “app store” or “applications store”, for free or for a fee, or which may be pre-installed on a computing device or electronic device, or which may be otherwise transported to and/or installed on such computing device or electronic device.

Functions, operations, components and/or features described herein with reference to one or more implementations, may be combined with, or may be utilized in combination with, one or more other functions, operations, components and/or features described herein with reference to one or more other implementations. Some embodiments may comprise any possible or suitable combinations, re-arrangements, assembly, re-assembly, or other utilization of some or all of the modules or functions or components or units that are described herein, even if they are discussed in different locations or different chapters of the above discussion, or even if they are shown across different drawings or multiple drawings.

While certain features of some demonstrative embodiments have been illustrated and described herein, various modifications, substitutions, changes, and equivalents may occur to those skilled in the art. Accordingly, the claims are intended to cover all such modifications, substitutions, changes, and equivalents.

What is claimed is:

1. A computerized method comprising:
(a) receiving from two parties to a dispute, textual statements that define each party positions with regard to the dispute;
(b) sending to each party a copy of the textual statements of the other party, and obtaining from each party responses to each textual statement sent to him, wherein each response is a selection among True or False or Pass, wherein the responses are collected from a first party before the first party receives a copy of the responses of the second party;
(c) receiving from said two parties additional textual statements with updated positions with regard to said dispute;
(d) iteratively performing steps (b) and (c) with regard to statements and responses, until a pre-defined condition holds true;
(e) based on analysis of said textual statements and responses, generating a textual description of a pin-pointed core of said dispute;
wherein said computerized method is implemented by at least a hardware processor.

2. The computerized method of claim 1,
wherein step (d) comprises:
iteratively performing steps (b) and (c) with regard to statements and responses, for a pre-defined number of iterations.

3. The computerized method of claim 1,
wherein step (d) comprises:
iteratively performing steps (b) and (c) with regard to statements and responses, for a pre-defined time-period.

4. The computerized method of claim 1,
wherein step (d) comprises:
iteratively performing steps (b) and (c) with regard to statements and responses, and in parallel tracking a percentage of disagreed positions of said parties, until said percentage of disagreed positions is smaller than a pre-defined threshold value.

5. The computerized method of claim 1,
wherein step (e) comprises:
tagging as True any particular response statement of any of said two parties, that was marked as Pass by at least one of said two parties; and counting said particular response statement as a position that is agreed by both of said two parties.

6. The computerized method of claim 1, further comprising:
enforcing a pre-defined constraint on the number of times that a particular party can respond with Pass;
detecting that one of said parties has responded with Pass to at least N statements, and generating a notification indicating an automatic determination that said party no longer wishes to continue with said computerized method to resolve said dispute.

7. The computerized method of claim 1, further comprising:
enforcing a pre-defined constraint on the number of times that a particular party can respond with Pass, within a batch of multiple iterations of statements.

8. The computerized method of claim 1, further comprising:
enforcing a pre-defined constraint on the number of statements that a particular party can enter within a single iteration of said computerize method.

9. The computerized method of claim 1, further comprising:
enforcing a pre-defined constraint on the number of statements that a particular party can enter within a batch of multiple iterations of said computerize method.

10. The computerized method of claim 1,
wherein step (e) comprises:
generating an output of narrowed-down dispute points, which comprises: (i) all statements made by the first party, to which the second party responded with False; and (ii) all statements made by the second party, to which the first party responded with False;
wherein said output of narrowed-down dispute points, excludes any statements made by either party, to which the response of the other party was either True or Pass.

11. The computerized method of claim 1, comprising:
applying an Artificial Intelligence (AI) dispute resolution algorithm, that parses: (i) all statements made by the first party, to which the second party responded with False; and (ii) all statements made by the second party, to which the first party responded with False;
wherein said AI dispute resolution algorithm generates a decision on said dispute based on said parsed statements.

12. The computerized method of claim 1, comprising:
applying an Artificial Intelligence (AI) dispute resolution algorithm, that parses: (i) all statements made by the first party, to which the second party responded with False; and (ii) all statements made by the second party, to which the first party responded with False;
wherein said AI dispute resolution algorithm determines an internal contradiction between two or more statements made by the first party;
wherein said AI dispute resolution algorithm generates a decision on said dispute based on said parsed statements and based on said internal contradiction.

13. The computerized method of claim 1,
wherein each iteration of steps (b) and (c) is performed within a pre-defined time-period that is allocated and enforced;
wherein the computerized method enforces a gradual hiding and gradual exposure scheme, which selectively hides from the first party one or more statements that the second party already provided during a current iteration, based on pre-defined rules for gradual hiding and gradual exposure of statements.

14. The computerized method of claim 1,
wherein upon each iteration of steps (b) and (c), the computerized method comprises at least one of:
dynamically updating an on-screen disagreement meter to reflect a current percentage of currently-disagreed statements out of an entirety of statements that were provided so far by said parties.
dynamically updating an on-screen agreement meter to reflect a current percentage of currently-agreed statements out of the entirety of statements that were provided so far by said parties.

15. The computerized method of claim 14,
wherein, once the current percentage of currently-disagreed statements is below a pre-defined threshold value, or once the current percentage of currently-agreed statements is above a pre-defined threshold value, said computerized method comprises:
triggering a dispute resolution unit to automatically generate a resolution with regard to said dispute based on evaluation of the statement made by said parties.

16. The computerized method of claim 1, comprising:
generating a mapped dispute overview, which comprises: (i) a first output with all statements that are currently disputed, (ii) a second output with all statements that are currently undisputed, (iii) a third output with all statements that at least one party has responded to with Pass;
generating a proposal to refer disputed statements to one or more dispute resolving entities.

17. The computerized method of claim 1,
wherein upon reception of a party response of either True or Pass, towards a previous statement that was made by the other party, the computerized method marks said previous statement as a statement that is no longer in dispute between the two parties.

18. The computerized method of claim 1,
wherein said two parties to said dispute are a single entity which provides statements for and against a decision that said single entity has a dilemma about;
wherein the computerized method operates to enable said single entity to resolve said dilemma based on mapping of statements related to said dilemma.

19. The computerized method of claim 1, comprising:
(I) training a Neural Network (NN) Unit with a training-set which comprises data-items describing a plurality of legal disputes, wherein for each legal dispute the training-set comprises at least (i) statements made by a first party, and (ii) statements made by a second party, and (iii) a court-decided outcome of the legal dispute;
(II) generating a fresh outcome to said dispute between said two parties, by feeding to said NN Unit a collection of disputed statements and undisputed statements of said two parties, and generating by said NN Unit a dispute outcome.

20. A computerized system comprising:
a statement reception unit, to receive a first set of initial statements (S1) from a first entity (E1), and to receive a second set of initial statements (S2) from a second entity (E2); wherein the first and second sets of initial statements (S1, S2) pertain to a same disputed subject-matter;
a statement exchange unit, to send to the second entity (E2) a copy of the first set of initial statements (S1), and to send in parallel to the first entity (E1) a copy of the second set of initial statements (S2);
a response collection unit, to collect from the first entity (E1) a first set of discrete responses (R1) to each one of the initial statements in the second set of initial statements (S2), wherein each response from the first entity (E1) is either True or False or Pass;
wherein the response collection unit is to further collect in parallel, from the second entity (E2), a second set of discrete responses (R2) to each one of the initial statements in the first set of initial statements (S1), wherein each response from the second entity (E2) is either True or False or Pass;
a feedback collection unit, which operates after the first set of responses (R1) is received from the first entity (E1) and after the second set of responses (R2) is received from the second entity (E2);
wherein the feedback collection unit is to collect from the first entity (E1) a first set of additional statements (A1) only with regard to False response statements (R2) of the second entity (E2);
wherein the feedback collection unit is to collect from the second entity (E2) a second set of additional statements (A2) only with regard to False response statements (R1) of the first entity (E2);
wherein the response collection unit is to collect from the first entity (E1) another set of discrete responses (RR1) to each one of the additional statements (A2) of the second entity (E2), wherein each response (RR1) from the first entity (E1) is either True or False or Pass;
wherein the response collection unit is to collect from the second entity (E2) another set of discrete responses (RR2) to each one of the additional statements (A1) of the first entity (E1), wherein each response (RR2) from the second entity (E1) is either True or False or Pass;
a dispute narrowing-down unit, to process said initial statements (S1, S2) and responses (R1, R2) and additional statements (A1, A2) and additional responses (RR1, RR2) generate an output indicating a narrowed-down description of said dispute relative to the initial statements (S1, S2).
